(19) United States
(12) Patent Application Publication
(10) Pub. No.: US 2015/0036997 A1
(43) Pub. Date: Feb. 5, 2015

(54) RECORDING APPARATUS AND RECORDING METHOD

(71) Applicant: CANON KABUSHIKI KAISHA, Tokyo (JP)

(72) Inventor: Noboru Omori, Yokohama-shi (JP)

(21) Appl. No.: 14/341,224

(22) Filed: Jul. 25, 2014

(30) Foreign Application Priority Data
Jul. 30, 2013 (JP) 2013-158276

(51) Int. Cl. H04N 5/77; H04N 9/79

(52) U.S. Cl. CPC H04N 5/77; H04N 9/79
USPC 386/226

(57) ABSTRACT

A recording apparatus of this invention has an interval recording mode in which recording of a predetermined recording time worth of moving image data is repeated each time a predetermined interval period elapses. In the interval recording mode, recording in the interval recording mode is terminated if it is determined that joined moving image data obtained by joining together moving image data recorded as separate moving image files cannot be recorded in the available area of a recording medium. Also, if a joining instruction is input, joined moving image data is generated and recorded into the recording medium. A series of moving images shot in the interval recording mode can therefore be played back easily.

### BACKGROUND OF THE INVENTION

1. Field of the Invention

The present invention relates to a recording apparatus and a recording method, and in particular relates to a recording apparatus and recording method capable of interval recording.

2. Description of the Related Art

There is a conventionally known recording apparatus that shoots a moving image and records it into a recording medium such as a memory card. One example of this type of recording apparatus has an interval shooting function for shooting a moving image for a certain time (number of frames) at a predetermined time interval (see Japanese Patent Laid-Open No. 2012-80340).

In the case where moving image data obtained in each instance of shooting in an interval recording mode is recorded as a separate moving image file, playing back a series of moving images shot in the interval recording mode has required the user to separately instruct the playback of each moving image.

### SUMMARY OF THE INVENTION

The present invention addresses this problem in conventional technology and provides a recording apparatus and recording method by which a series of moving images shot in an interval recording mode are recorded so as to be able to be played back easily.

According to an aspect of the present invention, there is provided a recording apparatus comprising: a recording unit configured to record moving image data, wherein the recording unit has an interval recording mode in which recording of a predetermined recording time worth of moving image data is repeated each time a predetermined interval period elapses, and the recording unit records each predetermined recording time worth of moving image data into a recording medium as a separate moving image file in the interval recording mode; a control unit configured to, in the interval recording mode, terminate recording in the interval recording mode in a case of determining that joined moving image data obtained by joining together moving image data recorded by the recording unit as separate moving image files will not be able to be recorded in an available area of the recording medium; and a generation unit configured to generate the joined moving image data using the moving image data recorded in the recording medium in the interval recording mode, wherein in accordance with a joining instruction, the control unit controls the generation unit so as to generate the joined moving image data and controls the recording unit so as to record the joined moving image data generated by the generation unit into the recording medium.

According to another aspect of the present invention, there is provided a recording method comprising: a recording step of, in an interval recording mode in which recording of a predetermined recording time worth of moving image data is repeated each time a predetermined interval period elapses, recording each predetermined recording time worth of moving image data into a recording medium as a separate moving image file; a control step of, in the interval recording mode, terminating recording in the interval recording mode in a case of determining that joined moving image data obtained by joining together moving image data recorded in the recording step as separate moving image files will not be able to be recorded in an available area of the recording medium; a generating step of, in accordance with a joining instruction, generating the joined moving image data using the moving image data recorded in the recording medium in the interval recording mode; and a step of recording the joined moving image data into the recording medium.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a digital camera as one example of a recording apparatus according to an embodiment of the present invention.

FIG. 2 is a flowchart showing processing in an interval recording mode according to an embodiment.

FIG. 3 is a flowchart showing recording continuation determination processing according to a first embodiment.

FIGS. 4A and 4B are diagrams schematically showing the positional relationship between recording areas of a recording medium and moving image data that has been recorded during recording in the interval recording mode.

FIG. 5 is a flowchart showing recording continuation determination processing according to a second embodiment.

FIGS. 6A and 6B are diagrams schematically showing the positional relationship between recording areas of a recording medium and moving image data that has been recorded during recording in the interval recording mode.

### DESCRIPTION OF THE EMBODIMENTS

Exemplary embodiments of the present invention will now be described in detail in accordance with the accompanying drawings.

### First Embodiment

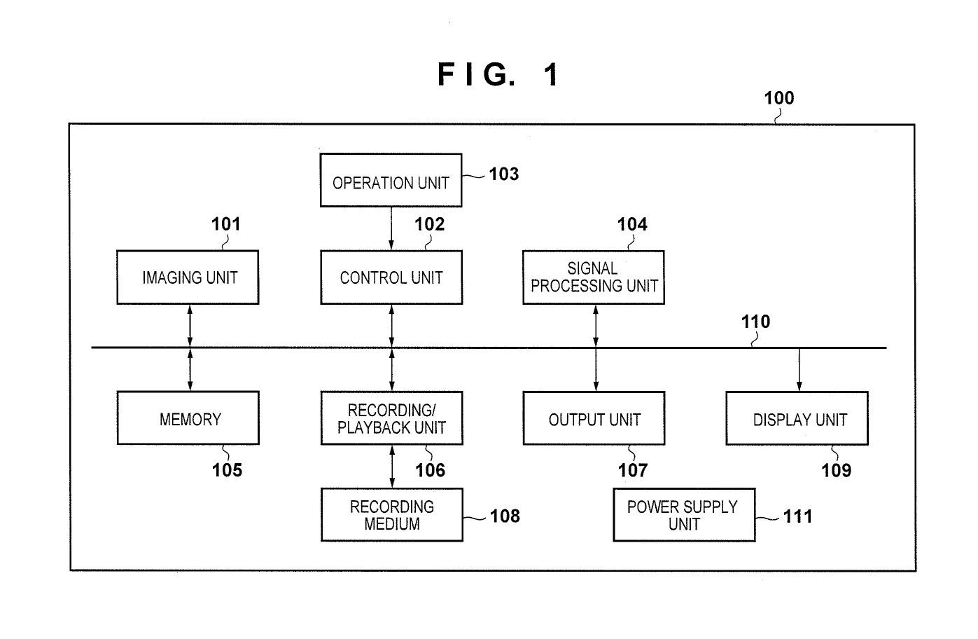

FIG. 1 is a block diagram showing an example of the configuration of a digital camera 100 as one example of a recording apparatus according to an embodiment of the present invention. Examples of the recording apparatus according to the present embodiment include not only an imaging apparatus, but also any electronic device that can record moving images obtained by interval shooting performed by an internal or connected camera. Examples of such an electronic device include a mobile phone, a tablet terminal, a game console, a personal computer, a navigation system, and an appliance.

As shown in FIG. 1, an imaging unit 101 has an optical system, an imaging device, and the like, and outputs moving image data obtained by shooting a subject. Note that although the imaging unit 101 of the present embodiment outputs moving image data having 1920 pixels horizontally×1080 pixels vertically and a frame rate of 30 frames per second, the moving image data may have another number of pixels and frame rate.

A control unit 102 performs overall control of the operation of the digital camera 100 according to input from an operation unit 103. The control unit 102 includes a microcomputer (CPU), a memory, and the like, and controls the digital camera 100 in accordance with a computer program (software) stored on a non-volatile memory (not shown). Also, the control unit 102 has a built-in recording medium interface for the communication of data and commands with a recording/playback unit 106.

The operation unit 103 includes various types of switches, buttons, and the like for a user to perform operations. The operation unit 103 receives various types of instructions and the like from the user and notifies the control unit 102 of them. Also, the operation unit 103 includes a power switch, a switch for instructing the start, stop, etc. of moving image data recording, a switch for switching the operation mode of the digital camera 100, a switch for operating menu screens, and the like.

When recording is performed, a signal processing unit 104 encodes moving image data acquired by the imaging unit 101 into a known encoding format such as MPEG so as to compress the quantity of information. Also, when playback is performed, the signal processing unit 104 decodes moving image data read out from a recording medium 108 so as to expand the quantity of information.

A memory 105 temporarily stores moving image data acquired by the imaging unit 101, moving image data read out from the recording medium 108, and the like. Various function blocks of the digital camera 100 process the moving image data by accessing it in the memory 105. Also, besides moving image data, the memory 105 stores various types of information such as file system information and management information, and furthermore plays the role of a work memory or the like for when the control unit 102 executes programs.

The recording/playback unit 106 writes and reads moving image data and various types of information to and from the recording medium 108. When performing recording, the recording/playback unit 106 reads out moving image data stored in the memory 105, and writes it into the recording medium 108. Also, when performing playback, the recording/playback unit 106 reads out moving image data and audio data from the recording medium 108 and stores it in the memory 105. In the present embodiment, an SD memory card is used as the recording medium 108 that has recording modes with different minimum recording units, but there is no particular limitation on the medium format, and it is possible to use a general recording medium such as a hard disk (HDD) or a memory card of another standard.

Also, moving image data and various types of information that are to be recorded into the recording medium 108 are managed as files by the recording/playback unit 106 in accordance with a file system such as the FAT (File Allocation Table) file system. Furthermore, although the recording medium 108 is configured so as to be able to be mounted to and ejected from the digital camera 100 using a mounting and ejecting mechanism (not shown), a configuration is possible in which the recording medium 108 is built into the digital camera 100.

In the case where a moving image file including moving image data is to be read from or written into the recording medium 108, the control unit 102 controls the recording/playback unit 106 so as to read out file system data (management data) such as the FAT and directory information from the recording medium 108, and stores it in the memory 105. This file system data is data that indicates the file names, file sizes, data recording addresses, and the like of data recorded in the recording medium 108, and is information for managing files. Also, the control unit 102 controls the writing and reading of files in accordance with the readout file system data. The control unit 102 updates the file system data stored in the memory 105 in response to the writing of files into the recording medium 108. The updated file system data is then recorded in the recording medium 108 by the recording/playback unit 106 at a predetermined timing.

Also, an output unit 107 outputs played back moving image data to a display apparatus or the like outside the digital camera 100. A display unit 109 displays moving images and various types of information on a display apparatus such as a liquid crystal panel. A data bus 110 is used for the transmission and reception of data, various types of control commands, and the like between the function blocks of the digital camera 100. A power supply unit 111 supplies power received from a power supply such as a battery (not shown) to the function blocks of the digital camera 100. The control unit 102 of the present embodiment can control whether or not power is to be supplied from the power supply unit 111 to each of the function blocks of the digital camera 100.

The following describes modes for writing data into the recording medium 108 in the digital camera 100 of the present embodiment. The digital camera 100 of the present embodiment has a normal writing mode (first writing mode) in which data is written into the recording medium 108 in cluster units regardless of the SD speed class. The digital camera 100 also has a high-speed writing mode (second writing mode) in which data is written in AU units in accordance with the SD speed class. It should be noted that these writing modes are different from the normal (DS) mode and the high-speed (HS) mode of SD memory cards.

In the high-speed writing mode, the recording unit is an allocation unit (AU), whose size is an integral multiple of the size of a recording unit (RU), which is the minimum recording unit determined by the SD speed class. The size of the RU is an integral multiple of 16 KB, and is prescribed as the minimum size that corresponds to the speed class. Information regarding the AU and the RU is recorded on the SD memory card as card information (SD status), and thus can be acquired from the SD memory card when power is introduced or at any time.

Note that when reading or writing data to an SD memory card, the cluster size, which is the unit of management in the file system, and the RU size are generally the same, and the RU will be considered to be a cluster in the following description. It should be noted that the AU in an SD memory card is different from an allocation unit that is synonymous with a cluster in the FAT file system. Also, although a SD memory card has a prescribed speed class for guaranteeing the minimum write speed, the minimum write speed is guaranteed based on the premise of performing recording in AU units, and therefore writing in AU units can also be called writing in accordance with the speed class.

In the high-speed writing mode, data writing is performed after designating, from among the AUs of the recording medium 108, AUs whose cluster usage rate is zero, that is to say AUs in which all of the clusters making up the AU are empty. In this way, in the high-speed writing mode, data writing is performed in units of an AU, which is an area made up of a predetermined number of consecutive clusters, thus making it possible to perform high-speed data writing.

In contrast, in the normal writing mode, the digital camera 100 uses the cluster, which is the recording unit of the recording medium 108, as the unit of data writing. Since data writing is performed in cluster units in the normal writing mode, data writing requires a longer amount of time than in the high-speed writing mode.

The digital camera 100 of the present embodiment has a normal recording mode and an interval recording mode as recording modes. In the interval recording mode, an operation for capturing and recording a set recording time (number of frames) worth of moving image data (image data) is performed each time a predetermined interval period elapses. The user can set the normal recording mode or the interval recording mode by operating the operation unit 103.

Also, the time of one instance of recording (shooting) in the interval recording mode can be set by the user via the operation unit 103 from among multiple candidates that have been prepared in advance. For example, the user can select and set one of 0.5 seconds, 1 second, 5 seconds, and 10 seconds, which were prepared as candidate recording times. The control unit 102 stores information indicating the set recording time in the memory 105.

Also, the user can set the interval period by selecting one of multiple interval periods that have been prepared in advance. For example, 5 seconds, 10 seconds, 30 seconds, 1 minute, 10 minutes, and 1 hour are prepared as interval periods, and the user selects one of these interval periods. The user can furthermore set the number of times that recording is to be repeated in the interval recording mode. The control unit 102 stores information that indicates the set interval period and recording repetition number in the memory 105.

Also, the digital camera 100 of the present embodiment records each piece of moving image data obtained in one instance of shooting in the interval recording mode as a separate moving image file. This is done in order to suppress the power consumption of the digital camera 100 by interrupting the supply of power to unneeded blocks during standby until the start of the next shooting, thus making it possible to perform interval recording for an extended period of time even in the battery-driven state. For this reason, if interval recording has been carried out with the recording repetition number 100 for example, 100 moving image files will be recorded into the recording medium 108. Note that a certain amount of time is required to be able to start interval recording again after one instance of interval recording terminates and the power supply is interrupted, and the power supply is not cut off if the shooting interval (interval period) that was set is shorter than that amount of time. Note that in this case as well, separate moving image files may be recorded for each instance of interval shooting in order to reliably record captured moving image data.

The digital camera 100 of the present embodiment also has a function by which the pieces of moving image data stored in multiple moving image files that were recorded in the recording medium 108 in a series of interval shooting are joined and recorded as one moving image file into the recording medium 108. Details of this joining function will be described later.

The following describes recording operations of the digital camera 100 of the present embodiment, beginning with recording processing in the normal recording mode. When the recording medium 108 is newly mounted, or the digital camera 100 is powered on, the control unit 102 generates an AU table, which is information indicating the FAT clusters that correspond to each AU and their usage status, and stores the generated AU table in the memory 105. Specifically, based on the information read out from the recording medium 108, the control unit 102 detects the size of one cluster making up an AU based on the size of one AU and the number of clusters making it up. The control unit 102 then determines the FAT clusters that correspond to each AU based on the AU size, the cluster size, and the FAT. The AU table, which is information indicating information for specifying the corresponding FAT clusters (e.g., cluster numbers) for each AU and their usage status, is generated and stored in the memory 105. For example, in the case where an AU is made up of four clusters, and the size of the clusters making up the AU is equal to the FAT cluster size, four FAT cluster numbers can be stored in association with each AU in the AU table. The usage status of each cluster may be determined by referencing the FAT, or may be included in the table.

Upon receiving an instruction for moving to the moving image data recording mode from the operation unit 103 for example, the control unit 102 moves the digital camera 100 to the recording standby state, and waits for an instruction to start recording. The control unit 102 then executes a live-view display operation in the recording standby state, in which moving image shooting is performed with the imaging unit 101, and the obtained moving image is displayed on the display unit 109. When an instruction to start recording is input from the operation unit 103, the control unit 102 controls the signal processing unit 104 so as to read out moving image data that was input by the imaging unit 101 and stored in the memory 105, and start the encoding of the moving image data. The signal processing unit 104 stores the encoded data in the memory 105 again.

In the present embodiment, the rate of the encoded moving image data obtained by the signal processing unit 104 (amount of data generated per unit of time) is lower than the recording data rate of the recording medium 108 (amount of data written per unit of time). The encoded data therefore accumulates as it is stored in the memory 105. Each time the amount of encoded data stored in the memory 105 reaches a first predetermined amount, the recording/playback unit 106 reads out the encoded data from the memory 105 and records it into the recording medium 108. Also, if the amount of encoded data stored in the memory 105 falls to a second predetermined amount that is lower than the first predetermined amount, the recording/playback unit 106 temporarily stops the readout of encoded data from the memory 105, and interrupts the processing of recording into the recording medium 108. In this way, the recording/playback unit 106 intermittently executes recording according to the amount of encoded data accumulated in the memory 105. Note that if a file is not open when encoded data is to be recorded into the recording medium 108, the recording/playback unit 106 creates and opens a new file for recording encoded data, and records the encoded data as a moving image file.

Each time one instance of writing into the recording medium 108 is finished, the control unit 102 updates the file system data (management information) stored in the memory 105 based on the recording position of the encoded data that was written at that time and the like. The control unit 102 then controls the recording/playback unit 106 so as to read out the updated file system data from the memory 105 and record it into the recording medium. As previously mentioned, in the present embodiment, data writing is performed in accordance with the speed class. Accordingly, the recording/playback unit 106 detects unrecorded AUs (available AUs) among the AUs in the recording medium 108, and writes data to the unrecorded AUs.

Also, if an instruction to stop recording is received from the operation unit 103 during moving image recording, the control unit 102 stops the encoding of moving image data performed by the signal processing unit 104, and closes the file undergoing recording by the recording/playback unit 106. The control unit 102 also updates the content of the file system data and records it into the recording medium 108 using the recording/playback unit 106. At this time, even if an available area remains in the AU in which moving image data was being written when the recording was stopped (the last-recorded AU), data will be recorded to an unrecorded AU in the next instance of recording, and no data will be written to the last-recorded AU.

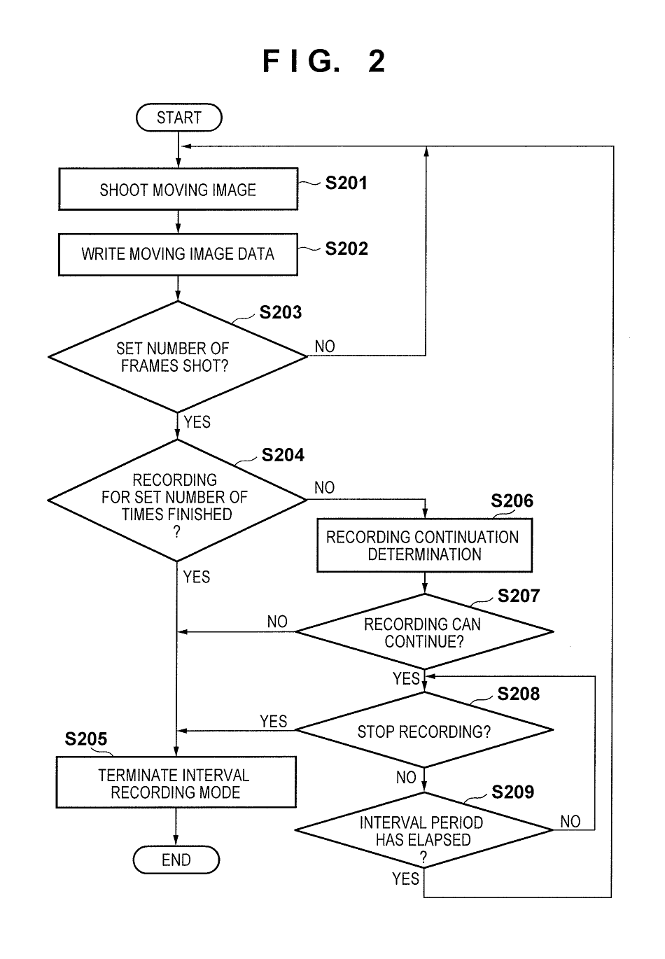

Next, processing for recording in the interval recording mode will be described. FIG. 2 is a flowchart showing processing in the interval recording mode. Note that the processing in FIG. 2 is executed by the control unit 102 controlling various units.

After the interval recording mode has been set, the processing of FIG. 2 is started if an instruction to start recording is received from the operation unit 103 in the recording standby state. Note that an instruction from the operation unit 103 is not necessary in another embodiment in which it is possible to designate a start time for interval recording (a specific time or the elapse of a predetermined time period).

The control unit 102 controls the imaging unit 101 so as to perform moving image shooting (step S201). Next, the control unit 102 controls the signal processing unit 104 so as to encode the moving image data and temporarily store the encoded data in the memory 105, and then controls the recording/playback unit 106 so as to read out the moving image data from the memory 105 and write it into the recording medium 108 (step S202). At this time, the control unit 102 controls the recording/playback unit 106 so as to write the data into the recording medium 108 in the high-speed writing mode (AU units) in accordance with the speed class.

Next, the control unit 102 determines whether or not the shooting and recording of one set recording time (number of frames) worth of moving image data is finished (step S203), and repeats the processing from step S201 until the recording of one recording time worth of moving image data is finished. Also, as previously described, one recording time worth of moving image data is recorded as one moving image file in the interval recording mode. When the recording of one recording time worth of moving image data is finished, the control unit 102 stops the supply of power from the power supply unit 111 to the imaging unit 101, the signal processing unit 104, and the recording/playback unit 106. This makes it possible to reduce power consumption in the interval period.

When the recording of one recording time worth of moving image data is finished, the control unit 102 determines whether or not recording for the set number of repetitions is finished (step S204). If recording for the set number of times is finished, the control unit 102 terminates the interval recording mode (step S205).

Also, if recording for the set number of times is not finished, the control unit 102 determines whether or not recording in the interval recording mode can be continued (step S206). This recording continuation determination processing will be described later. If the result of determining whether or not recording can be continued is that recording cannot be continued (No in step S207), the control unit 102 terminates the interval recording mode (step S205). On the other hand, if it was determined that recording can be continued (Yes in step S207), the control unit 102 determines whether or not an instruction to stop recording was received from the operation unit 103 (step S208). If an instruction to stop recording was received, the control unit 102 terminates the interval recording mode (step S205). If an instruction to stop recording has not been received, the control unit 102 determines based on the time measured by an internal timer whether or not the elapsed time since the termination of the immediately previous recording has reached the set interval period (step S209). If the interval period has not elapsed, the procedure returns to step S208, and the processing is repeated. If the interval period has been reached, the control unit 102 returns to step S201 and shoots and records a moving image again.

Note that as previously described, the supply of power to some function blocks is stopped in the interval period. For this reason, the control unit 102 controls the power supply unit 111 so as to start the supply of power to the function blocks at a time that is earlier than the interval period by the amount of time needed for the function blocks to start operating.

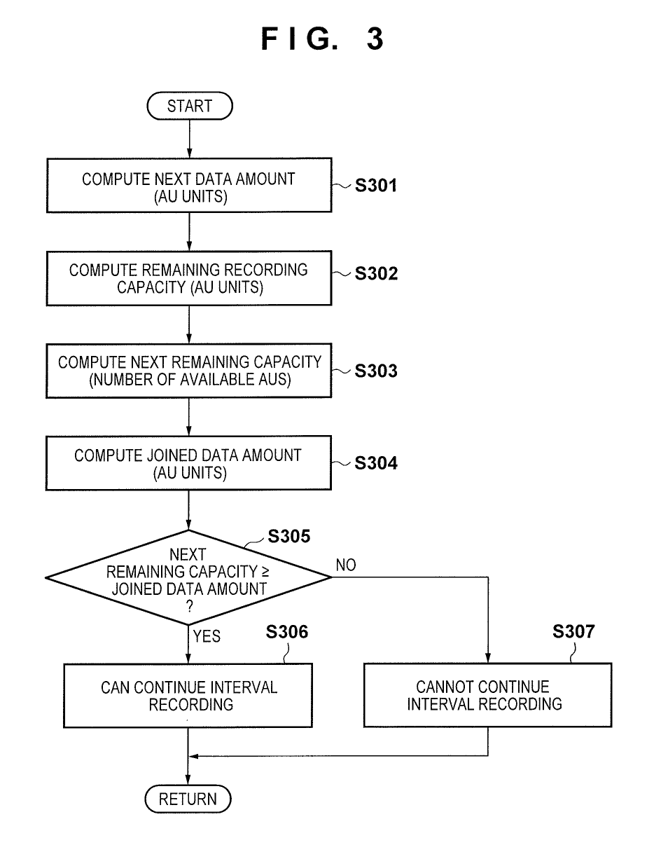

FIG. 3 is a flowchart showing the recording continuation determination processing in step S206. The control unit 102 first computes the data amount of the moving image data that is to be recorded in the next instance of recording (next data amount), in AU units (step S301). For example, letting the data rate of the encoded moving image data be a predetermined value, the control unit 102 obtains the amount of data that will be generated by multiplying the predetermined value by the number of frames in the recording time for one instance. The next data amount [AU] is then computed by dividing the obtained data amount by the AU size of the recording medium 108 and rounding up to an integer. Accordingly, the next data amount is the number of AUs needed in order to record the moving image data that is to be recorded next.

Next, the control unit 102 obtains the remaining recording capacity (i.e., the current capacity of an available area) of the recording medium 108 (step S302). In the present embodiment, the number of unrecorded AUs (available AUs) that do not have recorded clusters among the AUs in the recording medium 108 is detected by the control unit 102 as the remaining recording capacity [AU]. Furthermore, the control unit 102 computes the next remaining capacity [AU] taking into consideration the storage capacity needed for the next instance of recording, by subtracting the next data amount [AU] from the remaining recording capacity [AU] (step S303).

Next, the control unit 102 computes the amount of moving image data that would be obtained if the one or more moving image data pieces (moving image files) that have been recorded since the start of moving image data recording in the interval recording mode were joined to the moving image data that is to be recorded next (i.e., computes a joined data amount) (step S304). Then, based on the AU size, the control unit 102 computes the number of AUs that would be needed to record the joined data amount.

Next, the control unit 102 compares the next remaining capacity (number of AUs) and the next data amount (number of AUs), and determines whether or not the next remaining capacity is greater than or equal to the next data amount (step S305). If the next remaining capacity is greater than or equal to the next data amount, the control unit 102 determines that interval recording can be continued (step S306), and if the next remaining capacity is less than the next data amount, the control unit 102 determines that interval recording cannot be continued (step S307).

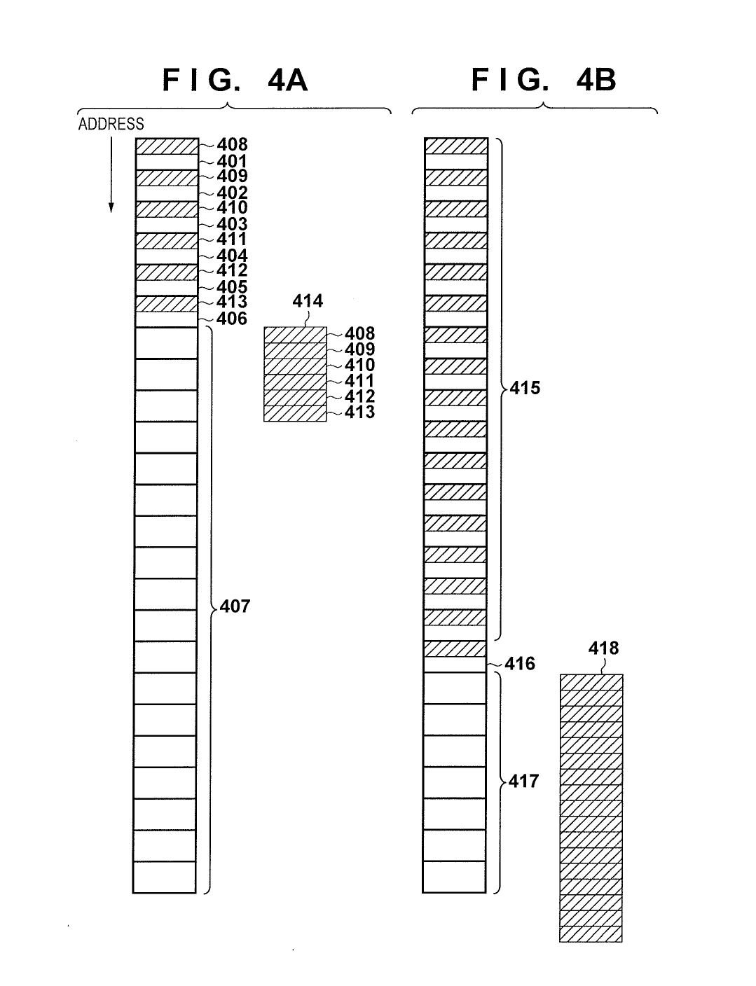

FIGS. 4A and 4B are diagrams schematically showing the positional relationship between recording areas of the recording medium 108 and moving image data that has been recorded during recording in the interval recording mode. It is assumed that the addresses increase from top to bottom in FIGS. 4A and 4B. In FIG. 4A, 401 to 406 each indicate one AU, and 407 indicates an available AU group. Assume that the amount of data recorded in one instance of recording in the interval recording mode is lower than the size of one AU, and data was written in the high-speed writing mode. In this case, moving image data has been recorded as shown by 408 to 412 in FIG. 4A after five instances of interval recording. Also, 413 indicates moving image data that is to be recorded next, and 406 indicates the AU to which moving image data is to be recorded next. In this case, the control unit 102 computes the AU 406 needed for the recording of the moving image data 413 that is to be recorded next as the next data amount, and computes the number of AUs in the available area 407. Thus, the next remaining capacity is the number of AUs in the available area 407. Also, 414 schematically shows the data amount of the moving image data that would be generated if the previously-recorded moving image data pieces 407 to 412 were joined to the next moving image data 413. In the case shown in FIG. 4A, the number of AUs in the available area 407 is greater than the number of AUs needed to record the joined moving image data 414, and therefore the control unit 102 determines that recording can be continued.

In FIG. 4B, 415 indicates AUs in which moving image data has been recorded. Also, 416 indicates an AU in which moving image data is to be recorded next. Thus, the control unit 102 computes the number of AUs in the available area 417 as the next remaining capacity. Also, 418 schematically shows the data amount of the moving image data that would be generated if the previously-recorded moving image data pieces were joined to the moving image data to be recorded next. In the case shown in FIG. 4B, the number of AUs in the available AU group 417 is lower than the number of AUs needed to record the joined moving image data 418, and therefore the control unit 102 determines that recording cannot be continued.

Next, processing for joining moving image data pieces that were recorded in the interval recording mode will be described. In the present embodiment, an instruction for joining a series of moving image files that were recorded in the interval recording mode can be given by the user in the normal recording mode or in the state in which recording is not being performed in the interval recording mode. Note that the state in which recording is not being performed in the interval recording mode includes not only a time after the termination of recording in the interval recording mode, but also an interval period. If joining processing is performed in an interval period, interval recording may be terminated at that point in time, or may be continued. If a joining instruction has been input from the user via the operation unit 103, the control unit 102 instructs the recording/playback unit 106 to play back the moving image files that were recorded in the recording medium 108 in the interval recording mode in order beginning with the moving image file that was recorded first. The recording/playback unit 106 reads out the moving image files that were recorded in the interval recording mode from the recording medium 108 in the order of recording, and transmits them to the signal processing unit 104. The signal processing unit 104 decodes the moving image data of the readout moving image files and temporarily stores the decoded moving image data in the memory 105. In parallel with the decoding, the signal processing unit 104 also successively reads out the decoded image data from the memory 105 and re-encodes the moving image data of multiple decoded moving image files into one continuous piece of moving image data. When joining multiple moving image files, data is re-encoded after being decoded once instead of being joined in the encoded state in order to improve the encoding efficiency at the junction between moving image files and reduce the possibility of obtaining an unnatural result at a junction in decoding processing after the joining.

The control unit 102 then controls the recording/playback unit 106 so as to record the data that was encoded as one piece of moving image data in this way as one moving image file. At this time, the control unit 102 instructs the recording/playback unit 106 to record the joined moving image data in the high-speed writing mode in accordance with the speed class.

In this way, in the present embodiment, the moving image data pieces included in multiple moving image files recorded in the interval recording mode are joined into one continuous moving image data piece and recorded as one moving image file. For this reason, the user can easily play back a series of moving image data pieces recorded in the interval recording mode by merely instructing the playback of the joined moving image file.

Also, in the present embodiment, the data amount that would be obtained if the moving image data to be recorded next were joined to the series of moving image data pieces that have been recorded in the interval recording mode is computed, and the interval recording mode is terminated if it is determined that this computed data amount exceeds the remaining recording capacity of the recording medium after the next instance of recording. In other words, if it is determined that the remaining recording capacity of the recording medium is less than or equal to the data amount of the joined moving image data, interval recording is terminated so as to prevent a situation in which the recording medium cannot store the moving image file obtained by joining the series of moving image data pieces recorded in the interval recording mode.

For this reason, moving image data obtained by joining together moving image data recorded as multiple moving image files in the interval recording mode can be reliably recorded into the recording medium.

### Second Embodiment

Next, a second embodiment of the present invention will be described. In the present embodiment as well, the configuration and basic operations of the digital camera 100 are similar to first embodiment, and redundant descriptions thereof will be omitted. In the present embodiment, in the interval recording mode, the digital camera 100 performs writing in cluster units instead of performing writing in accordance with the speed class (performing recording in AU units).

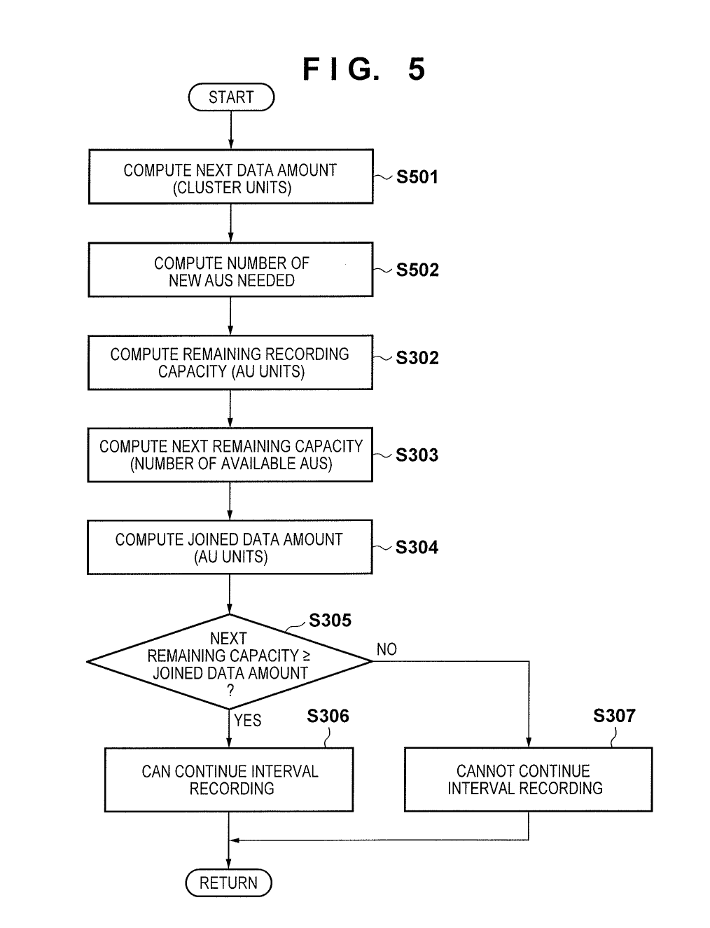

In the present embodiment, the recording continuation determination processing in step S206 of FIG. 2 is different from the first embodiment, and therefore the recording continuation determination processing of the present embodiment will be described below with reference to the flowchart in FIG. 5. In FIG. 5, steps for performing the same operations as in the first embodiment are denoted by the same reference numbers as in FIG. 3 and will not be described redundantly.

FIG. 5 is a flowchart showing recording continuation determination processing according to the second embodiment. The control unit 102 first computes the data amount of the moving image data that is to be recorded in the next instance of recording (next data amount), in cluster units (step S501). For example, letting the data rate of the encoded moving image data be a predetermined value, the control unit 102 computes the amount of data that will be generated by multiplying the predetermined value by the number of frames in the recording time for one instance. The control unit 102 can then obtain the number of clusters needed to record the moving image data that is to be recorded next by dividing the computed data amount by the cluster size of the recording medium 108 and rounding up to an integer.

Next, based on the computed number of clusters, number of clusters per AU, and number of remaining clusters in the AU that was used immediately previously, the control unit 102 computes the number of new AUs that would be needed (next number of AUs) if the moving image data were next recorded in cluster units (step S502).

For example, assume that four clusters make up one AU, three is computed as the number of clusters needed to record the moving image data that is to be recorded next, and one cluster is unused in the AU in which moving image data was last recorded immediately previously (last-recorded AU). In this case, the next moving image data will not fit in the unused cluster of the last-recorded AU, and therefore one new AU will be needed in addition to the last-recorded AU, and the next number of AUs is 1 [AU].

Next, the control unit 102 obtains the remaining recording capacity of the recording medium 108 (step S302). In the present embodiment, the number of unrecorded AUs (available AUs) that do not have recorded clusters among the AUs in the recording medium 108 is detected by the control unit 102 as the remaining recording capacity [AU]. Furthermore, the control unit 102 computes the next remaining capacity [AU] taking into consideration the storage capacity needed for the next instance of recording, by subtracting the next number of AUs [AU] from the remaining recording capacity [AU] (step S303). The subsequent processing will not be described since it is the same as in the first embodiment.

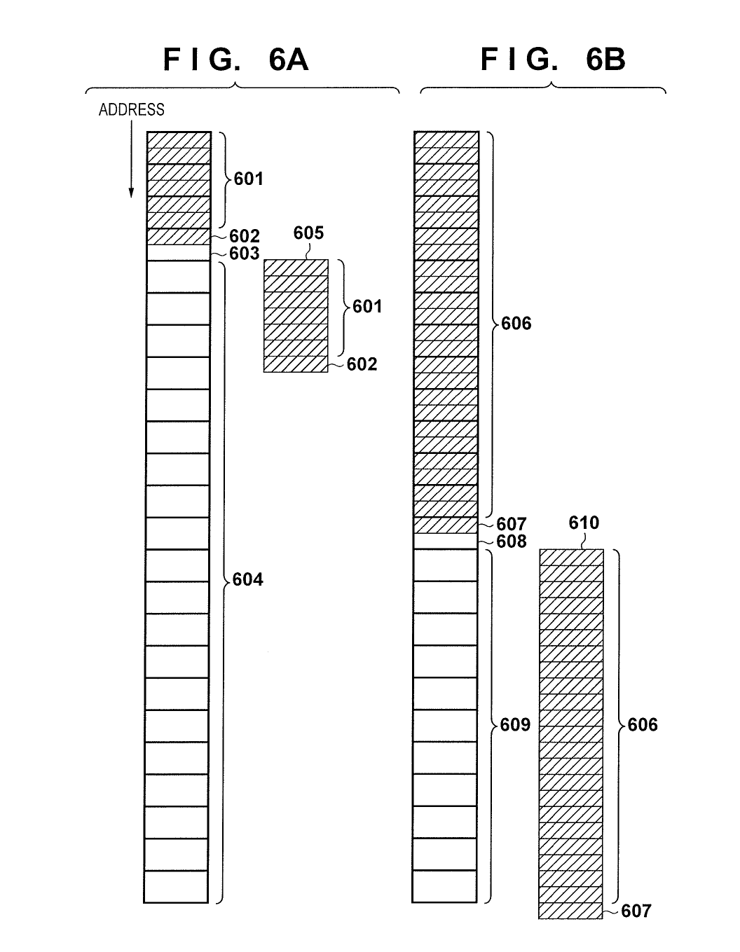

FIGS. 6A and 6B are diagrams schematically showing the positional relationship between recording areas of the recording medium 108 and moving image data that has been recorded during recording in the interval recording mode. Similarly to FIGS. 4A and 4B, it is assumed that the addresses increase from top to bottom. In FIG. 6A, 601 indicates moving image data pieces (and AUs) that have already been recorded, 602 indicates moving image data that is to be recorded next, 603 indicates an AU to which moving image data is to be recorded next, and 604 indicates an available area. In this case, only the AU 603 is needed to record the moving image data 602 that is to be recorded next, and therefore the next number of AUs is 1. Also, the next remaining capacity becomes the number of AUs in the available area 604 obtained by subtracting the next number of AUs from the current available capacity (sum of the AU 603 and the available area 604). Also, 605 indicates moving image data that would be generated if the previously-recorded moving image data 601 were joined to the next moving image data 602. In the case shown in FIG. 6A, the number of AUs in the available area 604 is greater than the number of AUs needed to record the joined moving image data 605, and therefore the control unit 102 determines that recording can be continued.

In FIG. 6B, 606 indicates moving image data pieces (and AUs) that have already been recorded, 607 indicates moving image data that is to be recorded next, 608 indicates an AU to which moving image data is to be recorded next, and 609 indicates an available area. In this case, only the AU 608 is needed to record the moving image data 607 that is to be recorded next, and therefore the next number of AUs is 1. Also, the next remaining capacity becomes the number of AUs in the available area 609 obtained by subtracting the next number of AUs from the current available capacity (sum of the AU 608 and the available area 609). Also, 610 indicates moving image data that would be generated if the previously-recorded moving image data 606 were joined to the next moving image data 607. In the case shown in FIG. 6B, the number of AUs in the available area 609 is lower than the number of AUs needed to record the joined moving image data 610, and therefore the control unit 102 determines that recording cannot be continued.

In this way, according to the present embodiment, in the interval recording mode, moving image data is written in the normal writing mode using the cluster as the writing unit, thus making it possible to reduce the amount of wasted recording area in the recording medium, in addition to the effects of the first embodiment.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-158276, filed on Jul. 30, 2013, which is hereby incorporated by reference herein its entirety.

What is claimed is:

1. A recording apparatus comprising:
a recording unit configured to record moving image data, wherein the recording unit has an interval recording mode in which recording of a predetermined recording time worth of moving image data is repeated each time a predetermined interval period elapses, and the recording unit records each predetermined recording time worth of moving image data into a recording medium as a separate moving image file in the interval recording mode;
a control unit configured to, in the interval recording mode, terminate recording in the interval recording mode in a case of determining that joined moving image data obtained by joining together moving image data recorded by the recording unit as separate moving image files will not be able to be recorded in an available area of the recording medium; and
a generation unit configured to generate the joined moving image data using the moving image data recorded in the recording medium in the interval recording mode,
wherein in accordance with a joining instruction, the control unit controls the generation unit so as to generate the joined moving image data and controls the recording unit so as to record the joined moving image data generated by the generation unit into the recording medium.

2. The recording apparatus according to claim 1,
wherein the control unit makes the determination based on:
a total data amount of moving image data of moving image files that have already been recorded in the recording medium and moving image data that is to be recorded in a next instance of interval recording; and
a recording capacity of the recording medium that is determined based on data amount of the moving image data to be recorded in the next instance of interval recording and a current capacity of an available area of the recording medium.

3. The recording apparatus according to claim 2,
wherein the control unit computes the data amount of the moving image data to be recorded in the next instance of interval recording based on a frame rate, predetermined data rate, and the predetermined recording time of the moving image data.

4. The recording apparatus according to claim 2,
wherein the control unit computes the data amount of the joined moving image data and the recording capacity of the recording medium in units of writing performed by the recording unit into the recording medium.

5. The recording apparatus according to claim 1, comprising:
an imaging unit,
wherein the recording unit records moving image data obtained by the imaging unit.

6. A recording method comprising:
a recording step of, in an interval recording mode in which recording of a predetermined recording time worth of moving image data is repeated each time a predetermined interval period elapses, recording each predetermined recording time worth of moving image data into a recording medium as a separate moving image file;
a control step of, in the interval recording mode, terminating recording in the interval recording mode in a case of determining that joined moving image data obtained by joining together moving image data recorded in the recording step as separate moving image files will not be able to be recorded in an available area of the recording medium;
a generating step of, in accordance with a joining instruction, generating the joined moving image data using the moving image data recorded in the recording medium in the interval recording mode; and
a step of recording the joined moving image data into the recording medium.

7. A non-transitory computer-readable storage medium storing a program for causing a computer to function as the recording apparatus according to claim 1.
